(19) United States
(12) Patent Application Publication
(10) Pub. No.: US 2010/0289463 A1
(43) Pub. Date: Nov. 18, 2010

(54) PRIMARY-SIDE FEEDBACK CONTROL DEVICE AND RELATED METHOD FOR A POWER CONVERTER

(76) Inventors: Yen-Hui Wang, Hsinchu City (TW); Chin-Yen Lin, Hsinchu County (TW); Chia-Chieh Hung, Taoyuan County (TW); Chi-Hao Wu, Taipei City (TW)

Correspondence Address: NORTH AMERICA INTELLECTUAL PROPERTY CORPORATION, P.O. BOX 506, MERRIFIELD, VA, 22116, US

(21) Appl. No.: 12/464,874

(22) Filed: May 13, 2009

(51) Int. Cl. G05F 1/625

(52) U.S. Cl. 323/247

(57) ABSTRACT

A primary-side feedback control device for a power converter includes a control unit, a comparator and a sample-and-hold unit. The control unit is utilized for generating a pulse signal according to a feedback signal for controlling on and off states of a switching transistor of the power converter. The comparator is coupled to an auxiliary winding of a primary side of the power converter, and is utilized for generating at least one control signal according to a voltage on the auxiliary winding. The sample-and-hold unit is coupled to the auxiliary winding, the comparator and the control unit, and is utilized for generating the feedback signal according to the voltage on the auxiliary winding and the at least one control signal.

### BACKGROUND OF THE INVENTION

1. Field of the Invention

The present invention relates to a feedback control device and related method for a power converter, and more particularly, to a feedback control device and related method for generating a feedback signal according to a voltage on an auxiliary winding of the primary side of a power converter.

2. Description of the Prior Art

A switching power supply (SPS) is used to convert AC power into DC regulated power for use by electronic equipment, and is widely used in a computer, an office automation system, industrial equipment and communications equipment. A power converter in a switching power supply can be of different types, e.g. a flyback converter, a forward converter, and a push-pull converter.

Please refer to FIG. 1, which is a schematic diagram of a power converter 10 according to the prior art. The power converter 10 is a flyback converter and comprises a transformer 100, a switch transistor 102, a pulse width modulation (PWM) control unit 104, an optocoupler 106, and a regulated and error amplifying circuitry 108 in which a shunt regulator diode TL431 is included. The transformer 100 comprises a primary winding Nₚ and an auxiliary winding N_{A} in the primary side and a secondary winding N_{S} in the secondary side for transferring energy and isolating an output terminal and an input terminal of the power converter 10. The PWM control unit 104 generates a pulse signal to control on and off states of the switching transistor 102 so as to control the transformer 100 to transfer a regulated input voltage V_{IN} to an output voltage V_{OUT}. When the switching transistor 102 is turned on, energy is stored in the primary winding Nₚ of the transformer 100; and when the switching transistor 102 is turned off, the energy stored in the primary winding Nₚ is delivered to the secondary winding N_{S} and therefore the output voltage V_{OUT} is generated. Note that when a current flows through the secondary winding N_{S}, variance of the output voltage V_{OUT} is sensed through the auxiliary winding N_{A}.

In order to make the output voltage V_{OUT} stable, a secondary-side feedback control scheme used in the power converter 10 is to amplify error of the output voltage V_{OUT} through the shunt regulator diode TL431 to generate a feedback signal and transfer the feedback signal to the PWM control unit 104 through the optocoupler 106 for performing feedback control. When the output voltage V_{OUT} varies, the PWM control unit 104 adjusts duty cycle of the pulse signal according to the feedback signal to control the switching transistor 102, for regulating the energy delivered to the load of the secondary side of the power converter 10.

However, the optocoupler 106 and the shunt regulator diode TL431 are expensive components and occupy a large space in the power converter 10, such that product cost of the power converter 10 cannot be reduced. Please refer to FIG. 2, which is s schematic diagram of a power converter 20 using primary-side feedback control according to the prior art. The power converter 20 is also a flyback converter and comprises a transformer 200, a switch transistor 202, a PWM control unit 204 and other necessary passive components not described here. Different from the power converter 10, the power converter 20 generates a feedback signal according to a voltage on an auxiliary winding N_{A} instead of using an optocoupler and a shunt regulator diode TL431. When current flows through the secondary winding N_{S} of the power converter 20, variance of the output voltage V_{OUT} is sensed through the auxiliary winding N_{A}.

In the power converter 20, the voltage on the auxiliary winding N_{A} is used as a feedback signal sent to the PWM control unit 204. The PWM control unit 204 adjusts duty cycle of a pulse signal according to the feedback signal to control the switching transistor 202 for regulating energy delivered to a load in the secondary side. Note that the power converter 20 shown in FIG. 2 is simplified. Actually, the power converter 20 is implemented with many more components. Even if product cost of the power converter 20 is much less than the power converter 10, it still has a lot of room for improvement.

### SUMMARY OF THE INVENTION

It is therefore a primary objective of the claimed invention to provide a primary-side feedback control device for a power converter and related power converter and method.

The present invention discloses a primary-side feedback control device for a power converter. The primary-side feedback control device comprises a control unit, a comparator and a sample-and-hold unit. The control unit is utilized for generating a pulse signal according to a feedback signal for controlling on and off states of a switching transistor of the power converter. The comparator is coupled to an auxiliary winding of a primary side of the power converter, and is utilized for generating at least one control signal according to a voltage on the auxiliary winding. The sample-and-hold unit is coupled to the auxiliary winding, the comparator and the control unit, and is utilized for generating the feedback signal according to the voltage on the auxiliary winding and the at least one control signal.

The present invention further discloses a power converter of primary-side feedback control. The power converter comprises an input terminal for receiving an input voltage, an output terminal for outputting an output voltage, a transformer comprising a primary winding coupled to the input terminal, an auxiliary winding coupled to the primary winding, and a secondary winding coupled to the output terminal for transferring the input voltage to the output voltage, a switching transistor coupled to the primary winding for controlling the transformer to store and transfer energy according to a pulse signal, and a feedback control device coupled to the switching transistor. The feedback control device comprises a control unit, a comparator and a sample-and-hold unit. The control unit is utilized for generating a pulse signal according to a feedback signal for controlling on and off states of a switching transistor. The comparator is coupled to an auxiliary winding and is utilized for generating at least one control signal according to a voltage on the auxiliary winding. The sample-and-hold unit is coupled to the auxiliary winding, the comparator and the control unit, and is utilized for generating the feedback signal according to the voltage on the auxiliary winding and the at least one control signal.

The present invention further discloses a feedback control method for a power converter. The feedback control method comprises generating a first voltage according to a voltage on a primary-side auxiliary winding of the power converter, comparing the voltage on the auxiliary winding with a reference voltage for generating a comparison result, generating at least one control signal according to the comparison result, and generating a feedback signal according to the first voltage and the at least one control signal, for controlling on and off states of a switching transistor of the power converter.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 and FIG. 2 are schematic diagrams of power converters according to the prior art.

FIG. 3 to FIG. 7 are schematic diagrams of power converters according to an embodiment of the present invention.

FIG. 8 is a voltage waveform diagram of signals in the power converter in FIG. 4.

FIG. 9 is a flowchart of a process according to an embodiment of the present invention.

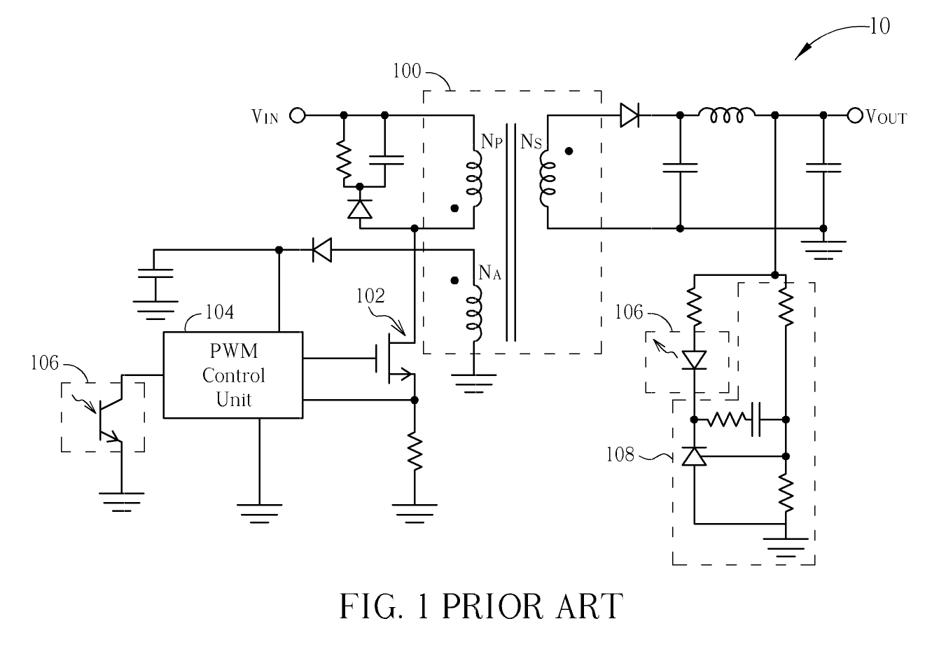

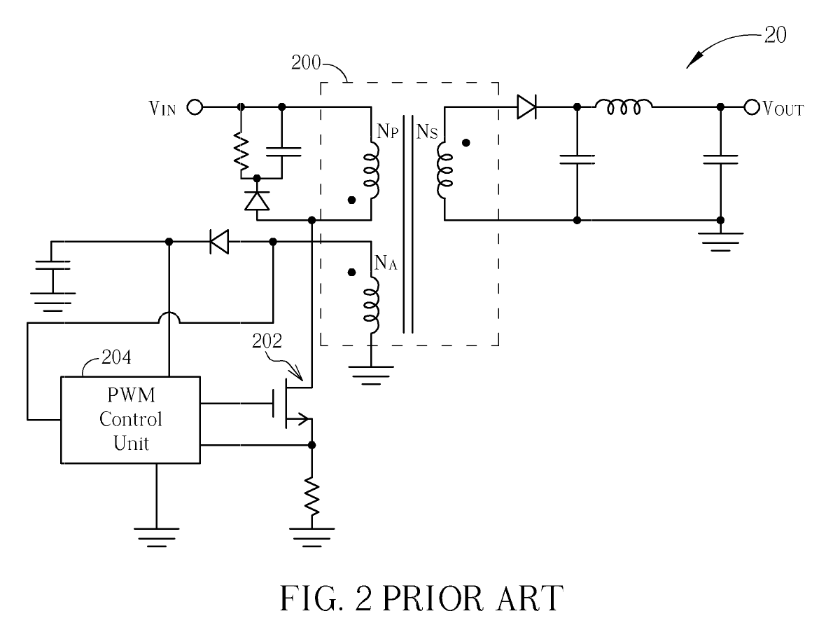

### DETAILED DESCRIPTION

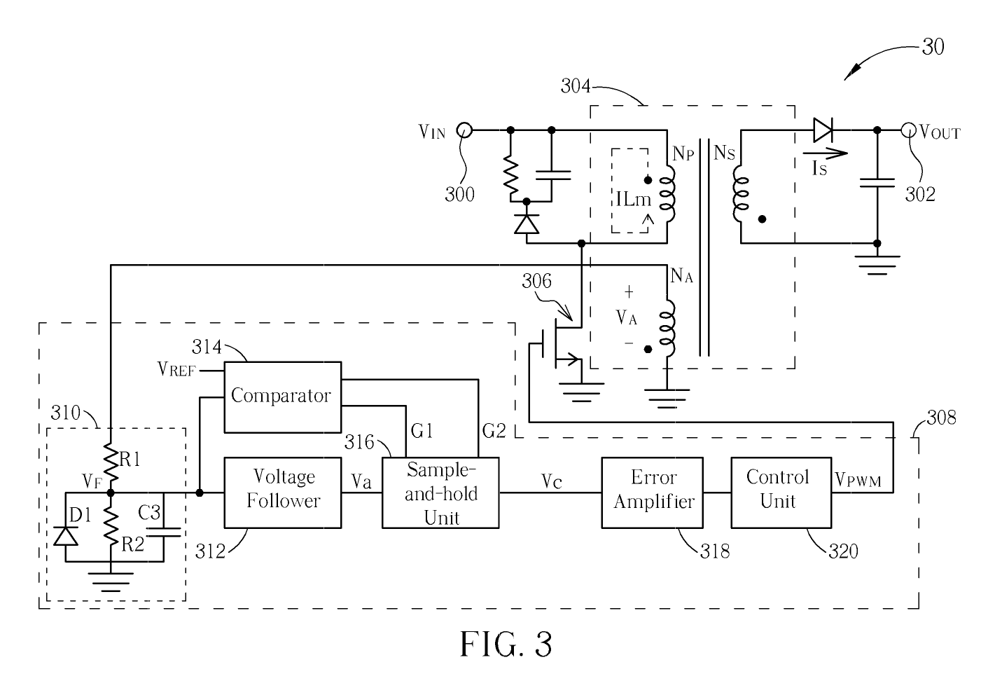

The present invention aims to provide a power converter with primary-side feedback control having lower production cost. Please refer to FIG. 3, which is a schematic diagram of a power converter 30 according to an embodiment of the present invention. The power converter 30 performs primary-side feedback control and comprises an input terminal 300, an output terminal 302, a transformer 304, a switching transistor 306 and a feedback control device 308. The power converter 30 receives an input voltage V_{IN} via the input terminal 300 and outputs an output voltage V_{OUT} via the output terminal 302. The transformer 304 comprises a primary winding N_{P} coupled to the input terminal 300, an auxiliary winding N_{A} coupled to the primary winding N_{P} and a secondary winding N_{S} coupled to the output terminal 302. The transformer 304 is utilized for transferring energy of the input voltage V_{IN} from the primary winding N_{P} to the secondary winding N_{S}, for generating the output voltage V_{OUT}.

The switching transistor 306 is coupled to the primary winding N_{P} and is utilized for controlling energy storage and transfer of the transformer 304 according to a pulse signal V_{PWM}. Utilization of on and off states of the switching transistor 306 to control the transformer 304 is described previously and is not repeated. The feedback control device 308 is coupled to the switching transistor 306 and comprises a voltage dividing unit 310, a voltage follower 312, a comparator 314, a sample-and-hold (S/H) unit 316, an error amplifier 318 and a control unit 320. The feedback control device 308 is utilized for generating a feedback signal and generating the pulse signal V_{PWM} according to the feedback signal for controlling on and off states of the switching transistor 306 according to the pulse signal V_{PWM}.

The feedback control device 308 is described in detail as follows. The voltage dividing unit 310 is utilized for dividing a voltage V_{A} on the auxiliary winding N_{A} because the voltage V_{A} on the auxiliary winding N_{A} has a higher voltage. When the voltage V_{A} on the auxiliary winding N_{A} varies, a divided voltage V_{F} outputted from the voltage dividing unit 310 varies correspondingly. The voltage follower 312 is coupled to the voltage dividing unit 310 and is utilized for outputting a voltage Vₐ following the divided voltage V_{F} to the S/H unit 316. In other words, variance of the voltage Vₐ outputted from the voltage dividing unit 310 follows variance of the voltage V_{A} on the auxiliary winding N_{A}.

The comparator 314 is coupled to the voltage dividing unit 310 and is utilized for comparing the divided voltage V_{F} with a reference voltage V_{REF} for generating a comparison result and outputting a first control signal G1 and a second control signal G2 according to the comparison result. The S/H unit 316 is coupled to the voltage follower 312 and the comparator 314 and is utilized for generating the feedback signal according to the voltage Vₐ, the first control signal G1 and the second control signal G2. The error amplifier 318 is coupled to the S/H unit 316 and the control unit 320 and is utilized for amplifying an error of the feedback signal for output to the control unit 320. The control unit 320 is coupled to the error amplifier 318 and the switching transistor 306 and is utilized for generating the pulse signal V_{PWM} according to the signal outputted from the error amplifier 318, for controlling on and off states of the switching transistor 306.

When the voltage V_{A} on the auxiliary winding N_{A} comes to a specific voltage, the divided voltage V_{F} comes to the reference voltage V_{REF}. At the same time, the voltage follower 312 outputs the voltage Vₐ following the divided voltage V_{F} to the S/H unit 316, and the comparator 314 outputs the first control signal G1 and the second control signal G2 to the S/H unit 316. The S/H unit 316 samples the voltage Vₐ according to the first control signal G1 and the second control signal G2, for generating the feedback signal. In other words, the feedback signal is generated according to the voltage V_{A} on the auxiliary winding N_{A}. Next, the error amplifier 318 amplifies the error of the feedback signal, and the control unit 320 generates the pulse signal V_{PWM} for controlling on and off states of the switching transistor 306.

As shown in FIG. 3, the voltage dividing unit 310 comprises resistors R1 and R2, a diode D1 and a capacitor C3. The resistors R1 and R2 are used to divide the voltage V_{A} on the auxiliary winding N_{A} to generate the divided voltage V_{F}. The resistor R1 has one terminal coupled to the auxiliary winding N_{A} and another terminal coupled to the voltage follower 312 and the comparator 314. The resistor R2 has one terminal coupled to the resistor R1, the voltage follower 312 and the comparator 314 and another terminal coupled to a ground terminal. The diode D1 and the capacitor C3 are used for stability. Cathode of the diode D1 is coupled to the resistors R1, R2, the voltage follower 312 and the comparator 314; anode of the diode D1 is coupled to the ground terminal. The capacitor C3 has one terminal coupled to the resistors R1, R2, the voltage follower 312 and the comparator 314 and another terminal coupled to the ground terminal. Note that the voltage dividing unit 310 in FIG. 3 is one of embodiments of the present invention, and the voltage dividing unit 310 can also be implemented by other circuitry.

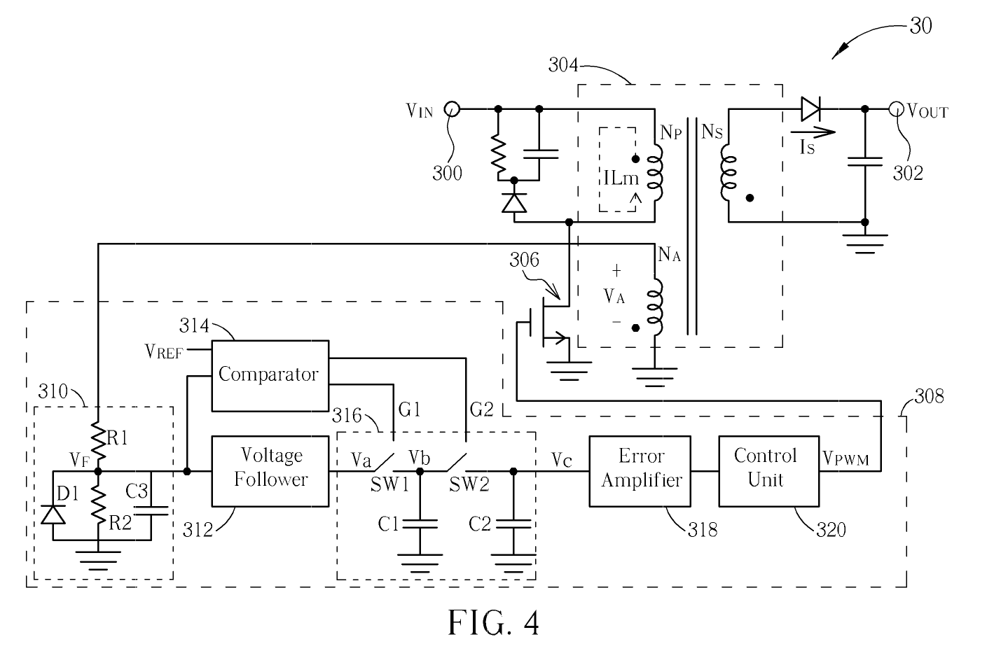

The S/H unit 316 is described in detail as follows. The S/H unit 316 comprises at least one switch and one capacitor. Please refer to FIG. 4, which is also a schematic diagram of the power converter 30. In FIG. 4, the S/H unit 316 further comprises switches SW1 and SW2 and capacitors C1 and C2. The switch SW1 is coupled to the voltage follower 312 and the comparator 314. The switch SW2 is coupled to the comparator 314, the switch SW1 and the error amplifier 318. The capacitor C1 has one terminal coupled to the switches SW1 and SW2 and another terminal coupled to the ground terminal. The capacitor C2 has one terminal coupled to the switch SW2 and the error amplifier 318 and another terminal coupled to the ground terminal. When a current flows through the secondary winding N_{S}, the variance of the output voltage V_{OUT} is sensed through the auxiliary winding N_{A}. The voltage dividing unit 310 divides the voltage V_{A} on the auxiliary winding N_{A} to generate the divided voltage V_{F}. The voltage follower 312 outputs the voltage Vₐ which follows the divided voltage V_{F} to the S/H unit 316. At the same time, when the comparison result generated by the comparator 314 indicates that the voltage V_{F} is higher than the reference voltage V_{REF}, the comparator 314 outputs the first control signal G1 to turn on the first switch SW1 and outputs the second control signal G2 to turn off the second switch SW2, so that the voltage Vₐ is stored on the capacitor C1, as a voltage V_{b}. When the comparison result indicates that the divided voltage V_{F} is lower than or equal to the reference voltage V_{REF}, the comparator 314 outputs the first control signal G1 to turn off the first switch SW1 and outputs the second control signal G2 to turn on the second switch SW2, so that the voltage V_{b} on the capacitor C1 is transferred to the capacitor C2, which generates the feedback signal having a voltage V_{c}. In other words, when the first switch SW1 is turned on and the second switch SW2 is turned off, the voltage V_{b} on the capacitor C1 is continuously tracking the divided voltage V_{F}; and, when the first switch SW1 is turned off and the second switch SW2 is turned on, the voltage V_{b} on the capacitor C1 is held at a knee of the divided voltage V_{F} and therefore the voltage V_{c} on the capacitor C2 is equal to the knee point voltage. The S/H unit 316 output the voltage V_{c} so that the control unit 320 generates the pulse signal V_{PWM} according to the feedback signal.

Note that, the feedback control device 308 shown in FIG. 3 and FIG. 4 is one embodiment of the present invention, and those skilled in the art can make alterations and modifications accordingly. For example, the voltage dividing unit 310 can be implemented by different circuitry. Besides, the comparator 314 can output only one control signal to the S/H unit 316, and the S/H unit 316 may generate required control signals, e.g. using an inverter to generate another control signal. In addition, switches and capacitors in the S/H unit 316 can be arranged differently for performing the sample-and-hold function. Any other device for generating a feedback signal by an S/H circuit should be included in embodiments of the present invention.

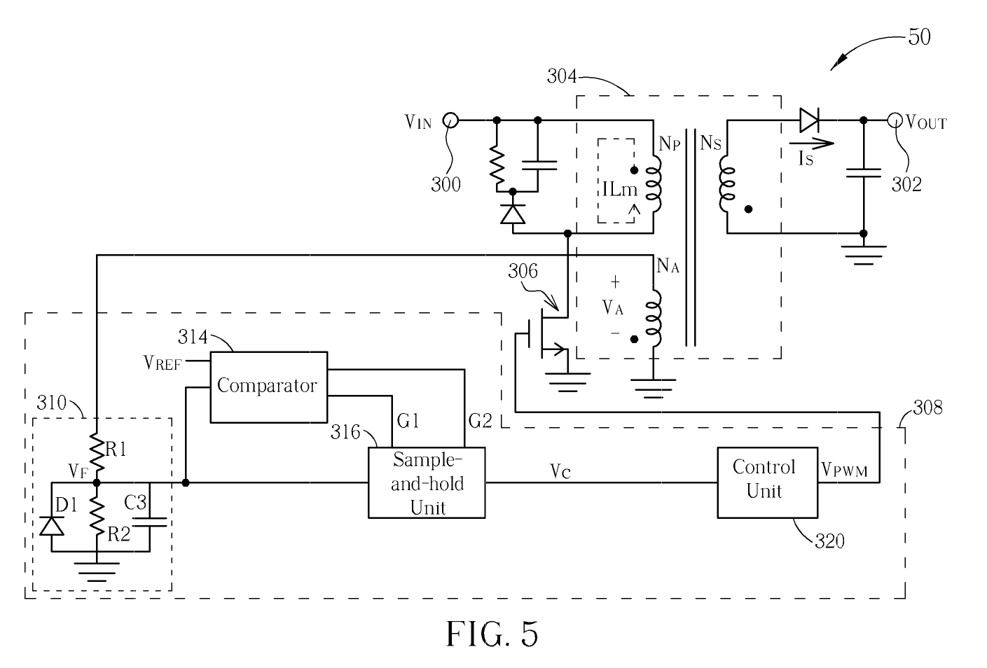

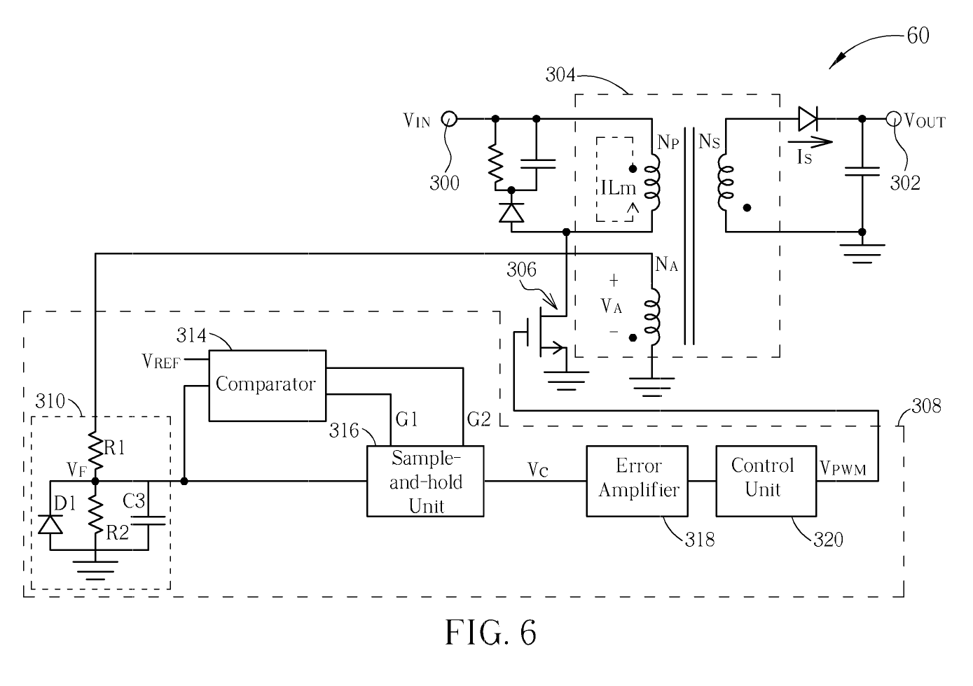

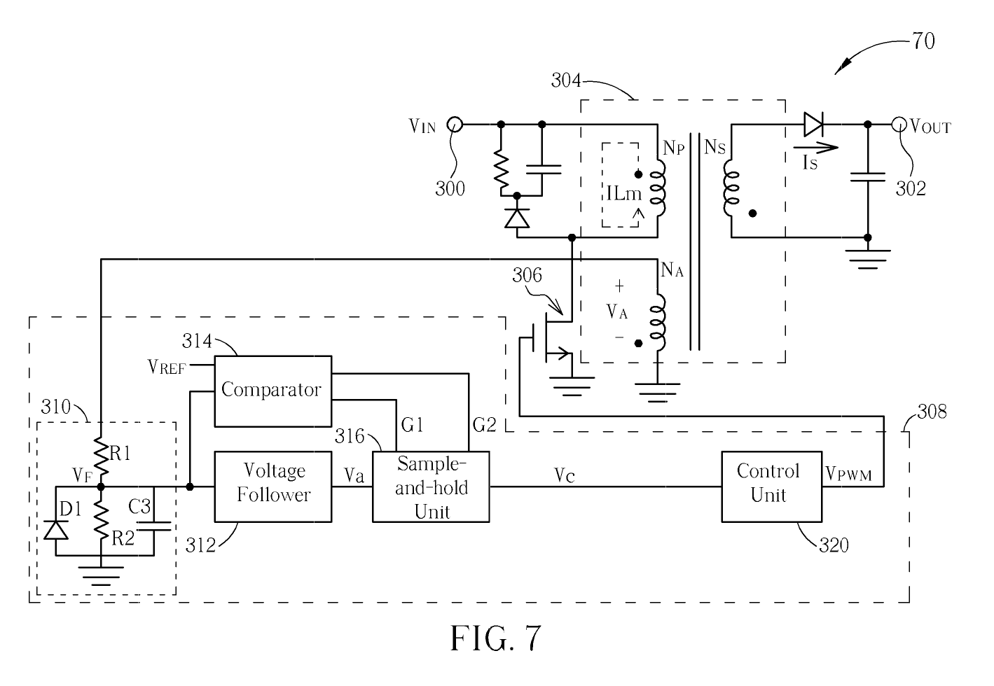

Furthermore, the voltage follower 312 and the error amplifier 318 are used or ignored depending on requirements. Please refer to FIG. 5 to FIG. 7, which are schematic diagrams of power converters 50, 60 and 70 according to embodiments of the present invention. The power converters 50, 60 and 70 are similar to the power converter 30, differing in that the power converter 50 does not include the voltage follower 312 and the error amplifier 318; the power converter 60 does not include the voltage follower 312; and the power converter 70 does not include the error amplifier 318. Operations of the power converters 50, 60 and 70 are similar to the power converter 30, and are not repeated again.

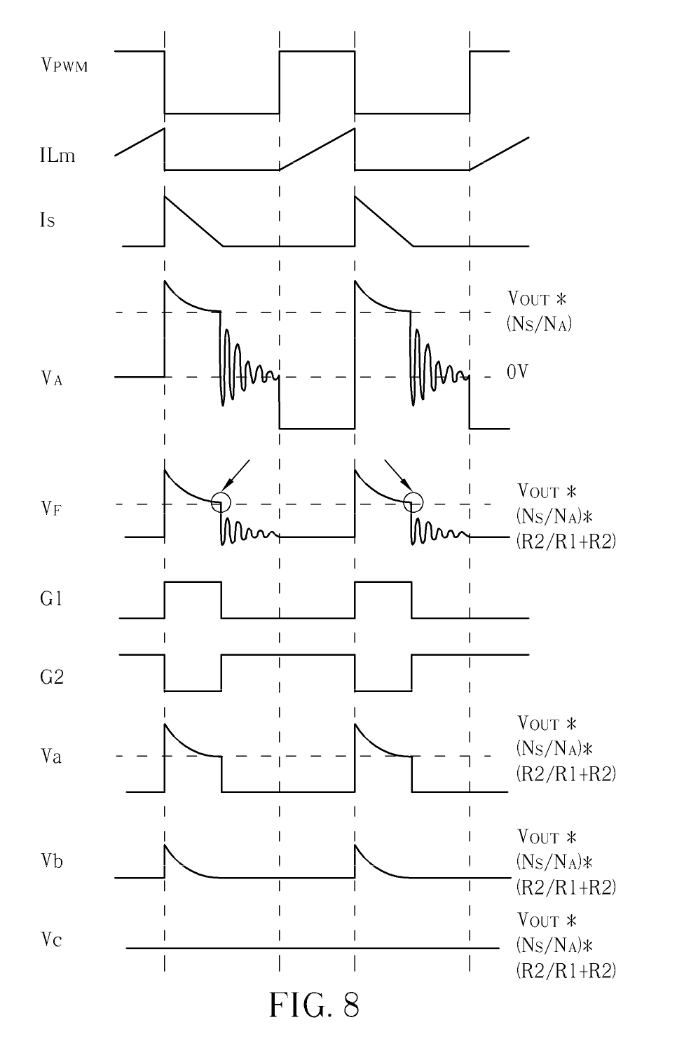

Please refer to FIG. 8, which illustrates a voltage waveform diagram of signals in the power converter 30 in FIG. 4, including the pulse signal V_{PWM}, a current ILm flowing through the primary winding N_{P}, a current Is flowing through the secondary winding Ns, the voltage V_{A} on the auxiliary winding N_{A}, the divided voltage V_{F}, the first control signal G1, the second control signal G2, the voltage Vₐ outputted from the voltage follower 312, the voltage V_{b} on the capacitor C1, and the voltage V_{c} on the capacitor C2 (which is also the voltage of the feedback signal). As shown in FIG. 8, a knee point of the voltage on the auxiliary winding N_{A} is V_{OUT}×(N_{S}/N_{A}); a knee point of the divided voltage V_{F} is V_{OUT}×(N_{S}/N_{A})×R2/(R1+R2). The voltage V_{b} on the capacitor C1 follows the divided voltage V_{F}; and the voltage V_{c} on the capacitor C2 is equal to the knee point of the divided voltage V_{F}.

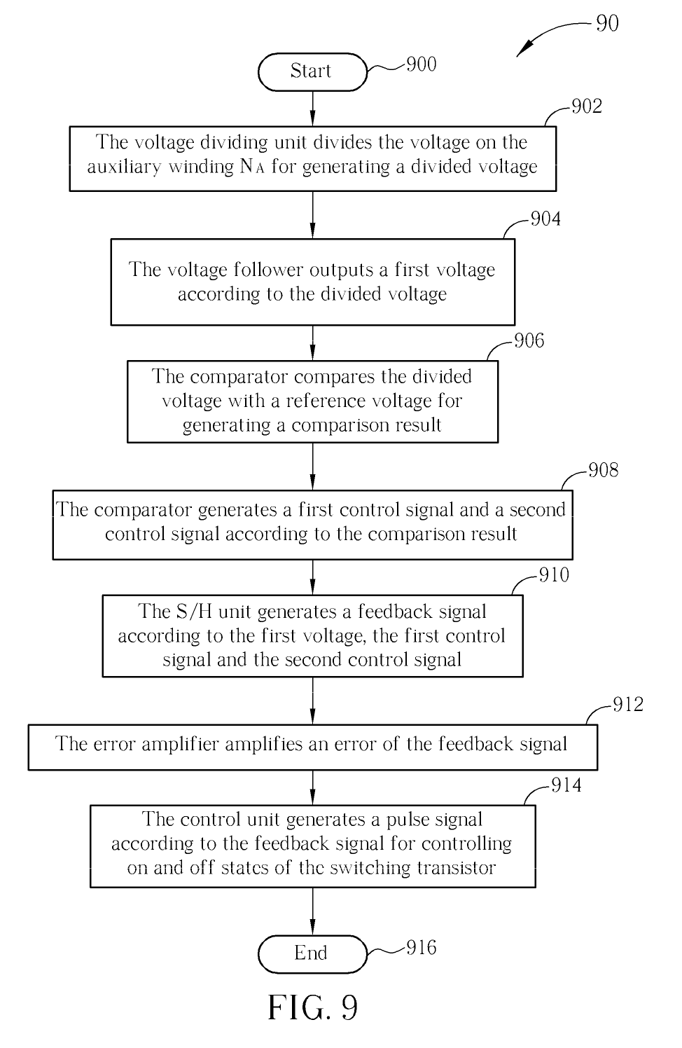

Please refer to FIG. 9, which is a flowchart of a process 90 utilized in the power converter 30 according to an embodiment of the present invention. The process 90 comprises the following steps:

Step 900: Start.

Step 902: The voltage dividing unit 310 divides the voltage on the auxiliary winding N_{A} for generating a divided voltage.

Step 904: The voltage follower 312 outputs a first voltage according to the divided voltage.

Step 906: The comparator 314 compares the divided voltage with a reference voltage for generating a comparison result.

Step 908: The comparator 314 generates a first control signal and a second control signal according to the comparison result.

Step 910: The S/H unit 316 generates a feedback signal according to the first voltage, the first control signal and the second control signal.

Step 912: The error amplifier 318 amplifies an error of the feedback signal.

Step 914: The control unit 320 generates a pulse signal according to the feedback signal for controlling on and off states of the switching transistor 306.

Step 916: End.

Please also refer to the power converter 30 mentioned previously to understand the process 90. Note that the process 90 is one of embodiments of the present invention, and those skilled in the art can make alterations and modifications accordingly. For example, if the power converter 30 does not comprise the voltage follower 312, Step 904 can be ignored; and if the power converter 30 does not comprise the error amplifier 318, Step 912 can be ignored. Besides, the S/H unit 316 in FIG. 4 is one embodiment, and the use of the process 90 is not limited by components included in the S/H unit 316. In Step 908, the comparator 314 generates the first control signal and the second control signal; in fact, the comparator 314 can generate only one control signal sent to another unit including an inverter to generate one more control signal.

In conclusion, the feedback control device according to the present invention is in the primary side of the power converter, and the feedback control device uses the comparator and the sample-and-hold unit to generate the feedback signal according to the knee of the voltage on the auxiliary winding. Therefore, the present invention does not need to use the optocoupler and the shunt regulator diode TL431, and thereby saves production cost of the power converter.

Those skilled in the art will readily observe that numerous modifications and alterations of the device and method may be made while retaining the teachings of the invention.

What is claimed is:

1. A primary-side feedback control device for a power converter, the primary-side feedback control device comprising:
a control unit for generating a pulse signal according to a feedback signal for controlling on and off states of a switching transistor of the power converter;
a comparator coupled to an auxiliary winding of a primary side of the power converter for generating at least one control signal according to a voltage on the auxiliary winding; and
a sample-and-hold unit coupled to the auxiliary winding, the comparator and the control unit for generating the feedback signal according to the voltage on the auxiliary winding and the at least one control signal.

2. The primary-side feedback control device of claim 1 further comprising a voltage follower coupled between the auxiliary winding and the sample-and-hold unit for outputting a voltage to the sample-and-hold unit according to the voltage on the auxiliary winding.

3. The primary-side feedback control device of claim 1 further comprising an error amplifier coupled between the sample-and-hold unit and the control unit for amplifying an error of the feedback signal.

4. The primary-side feedback control device of claim 1, wherein the sample-and-hold unit comprises at least one switch and one capacitor.

5. The primary-side feedback control device of claim 1, wherein the sample-and-hold unit comprises:
a first switch coupled to the comparator;
a second switch coupled to the comparator, the first switch and the control unit;
a first capacitor comprising one terminal coupled to the first switch and the second switch and another terminal coupled to a ground terminal; and
a second terminal comprising one terminal coupled to the second switch and the control unit and another terminal coupled to the ground terminal.

6. The primary-side feedback control device of claim 5, wherein when the voltage on the auxiliary winding is higher than a reference voltage, the comparator outputs a first control signal to turn on the first switch and outputs a second control signal to turn off the second switch, for transferring the voltage on the auxiliary winding to the first capacitor.

7. The primary-side feedback control device of claim 5, wherein when the voltage on the auxiliary winding is lower than or equal to a reference voltage, the comparator outputs a first control signal to turn off the first switch and outputs a second control signal to turn on the second switch, for transferring a voltage on the first capacitor to the second capacitor.

8. A power converter of primary-side feedback control comprising:
an input terminal for receiving an input voltage;
an output terminal for outputting an output voltage;
a transformer comprising a primary winding coupled to the input terminal, an auxiliary winding coupled to the primary winding, and a secondary winding coupled to the output terminal for transferring the input voltage to the output voltage;
a switching transistor coupled to the primary winding for controlling the transformer to store and transfer energy according to a pulse signal; and
a feedback control device coupled to the switching transistor comprising:
a control unit for generating the pulse signal according to a feedback signal for controlling on and off states of the switching transistor;
a comparator coupled to the auxiliary winding for generating at least one control signal according to a voltage on the auxiliary winding; and
a sample-and-hold unit coupled to the auxiliary winding, the comparator and the control unit for generating the feedback signal according to the voltage on the auxiliary winding and the at least one control signal.

9. The power converter of claim 8, wherein the feedback control device further comprises a voltage follower coupled between the auxiliary winding and the sample-and-hold unit for outputting a voltage to the sample-and-hold unit according to the voltage on the auxiliary winding.

10. The power converter of claim 8, wherein the feedback control device further comprises an error amplifier coupled between the sample-and-hold unit and the control unit for amplifying an error of the feedback signal.

11. The power converter of claim 8, wherein the sample-and-hold unit comprises at least one switch and one capacitor.

12. The power converter of claim 8, wherein the sample-and-hold unit comprises:
a first switch coupled to the comparator;
a second switch coupled to the comparator, the first switch and the control unit;
a first capacitor comprising one terminal coupled to the first switch and the second switch and another terminal coupled to a ground terminal; and
a second terminal comprising one terminal coupled to the second switch and the control unit and another terminal coupled to the ground terminal.

13. The power converter of claim 12, wherein when the voltage on the auxiliary winding is higher than a reference voltage, the comparator outputs a first control signal to turn on the first switch and outputs a second control signal to turn off the second switch, for transferring the voltage on the auxiliary winding to the first capacitor.

14. The power converter of claim 12, wherein when the voltage on the auxiliary winding is lower than or equal to a reference voltage, the comparator outputs a first control signal to turn off the first switch and outputs a second control signal to turn on the second switch, for transferring a voltage on the first capacitor to the second capacitor.

15. A feedback control method for a power converter, the feedback control method comprising:
generating a first voltage according to a voltage on a primary-side auxiliary winding of the power converter;
comparing the voltage on the auxiliary winding with a reference voltage for generating a comparison result;
generating at least one control signal according to the comparison result; and
generating a feedback signal according to the first voltage and the at least one control signal, for controlling on and off states of a switching transistor of the power converter.

16. The feedback control method of claim 15 further comprising:
generating a pulse signal according to the feedback signal for controlling on and off states of the switching transistor.

17. The feedback control method of claim 15 further comprising:
amplifying an error of the feedback signal.

18. The feedback control method of claim 15 further comprising:
dividing the voltage on the auxiliary winding for generating a divided voltage; and
generating the first voltage according to the divided voltage.

19. The feedback control method of claim 15, wherein the step of generating the at least one control signal according to the comparison result comprises generating a first control signal and a second control signal according to the comparison result.

20. The feedback control method of claim 19, wherein when the voltage on the auxiliary winding is higher than the reference voltage, the voltage on the auxiliary winding is transferred to a first capacitor according to the first control signal and the second control signal.

21. The feedback control method of claim 20, wherein when the voltage on the auxiliary winding is lower than or equal to the reference voltage, a voltage on the first capacitor is transferred to a second capacitor according to the first control signal and the second control signal for generating the feedback signal.
